(19) United States
(12) Patent Application Publication
(10) Pub. No.: US 2011/0168141 A1
(43) Pub. Date: Jul. 14, 2011

(54) FUEL ACTIVATION CATALYZER FOR AN ENERGY SAVER OF AN INTERNAL COMBUSTION ENGINE AND A MANUFACTURE METHOD THEREOF AND AN ENERGY SAVER USING THE CATALYZER

(76) Inventors: Youping Zhou, Jiangxi (CN); Xiaoquan Gao, Berra Ferrara (IT); Jiequan Gao, Zhejiang (CN)

(21) Appl. No.: 12/668,736

(22) PCT Filed: Jul. 13, 2007
(86) PCT No.: PCT/CN2007/070290

§ 371 Date: May 6, 2010

(51) Int. Cl. F02M 27/04; F02M 27/06; C04B 35/195

(52) U.S. Cl. 123/539; 123/536; 264/631

(57) ABSTRACT

A fuel activation catalyzer for an energy saver of an internal combustion engine is provided, which including nanometer negative ions and far infrared materials, and carrier of the nanometer negative ions material selecting from the following material's: cordierite ceramic material and/or limestone, wherein the weight of the nanometer negative ions and far infrared materials to the total weight of the nanometer negative ions and far infrared materials and the carrier is 5 wt %-30 wt %. And a manufacture method of the catalyzer for an energy saver of an internal combustion engine and an energy saver of an internal combustion engine using the catalyzer are also provided. By using the energy saver, the oil circuits and gas circuits are improved, the combustion is promoted and the heat value of the fuel is enhanced.

### FIELD OF THE PATENT APPLICATION

The present invention belongs to the field of oil savers, in particular relates to a fuel activation catalyzer for an energy saver of an internal combustion engine and a manufacture method thereof.

### BACKGROUND

Currently, aiming at the problems of energy saving of the internal combustion engine, many technical proposals are provided. The technical proposals play a good effect for fuel saving. A magnetizing oil saver is common in the market, after passing through the middle of the magnetic pole in the oil saver, fuel oil is magnetized to change the arrangement structure of molecules, lessen the van der waals force between the molecules and enlarge the motion between the molecules. The smaller the unimolecular group is, the easier the fuel oil combusts. Therefore, the fuel oil achieves the effect of atomization after being magnetized so as to promote combustion, improve the combustion efficiency of the fuel oil and reduce exhaust pollution, thereby achieving the goal of energy saving. However, since the magnetizing oil saver attaches micro iron-containing solid impurity in the fuel oil to the installation position of the magnetizing oil saver, as time passes, the passageway of the fuel oil gets narrower and oil supply may be cut off under a serious condition. In order to achieve the atomization effect, the magnetism of the magnetizing oil saver must be more than 5000 gauss which may affect the normal work of a control system of an automobile computer. In order to solve the problem, an energy saver made into various shapes from natural ore material capable of emitting far infrared ray is provided. The energy saver is substantially classified into a contact mode and a non-contact mode. The wave length of the far infrared ray emitted by the natural ore material is 5-15 um, and vibration frequency of the same is 260-300 Hz. The fuel oil is activated by the far infrared ray to improve the motion efficiency of molecules, atomize the fuel oil, and finally promote the complete combustion of the fuel oil, so that atomic group positive electric ions and atomic group negative electric ions in molecular group of the fuel oil can be evenly arranged, oil molecules with high fire point in the fuel oil can be instantaneously catalyzed and the fuel oil is atomized from liquid state to semi-gas state, however, the oil saver made from the natural material which is easily reacted with the fuel when contacts with the fuel may cause damage to an engine in the internal combustion engine due to low emissivity. If the oil saver does not contact with the fuel, although the far infrared ray emitted by the material has penetrability, the effect is weakened and the actual result can not be obtained since the wave length is only 5-14 um and the vibration frequency is low and is obstructed by an outer oil pipe.

### SUMMARY

Aiming at the problems of the prior art, the present patent application aims at providing a fuel activation catalyzer for an energy saver of an internal combustion engine, which includes nanometer composite material, can improve oil circuit and gas circuit, promotes combustion, increases the combustion heat value of the fuel, enhances the power of the internal combustion engine under equal fuel, and can avoid blocking an oil delivery pipe.

The present patent application further aims at providing a manufacture method of the fuel activation catalyzer for the energy saver of the internal combustion engine.

The present patent application further aims at providing an energy saver of an internal combustion engine using the fuel activation catalyzer.

In order to realize the aims, the present patent application adopts the following technical proposals:

The fuel activation catalyzer for the energy saver of the internal combustion engine includes nanometer negative ions and far infrared materials, and carrier of the nanometer negative ions material selected from the following materials: cordierite ceramic material, limestone, rubber, silicon alloy, and the like, wherein the weight of the nanometer negative ions and far infrared materials to the total weight of the nanometer negative ions and far infrared materials and the carrier is 5 wt %-30 wt %.

Preferably, the cordierite ceramic material or the limestone is taken as the carrier;

More preferably, the cordierite ceramic material is taken as the carrier.

The chemical composition of the cordierite ceramic material is MgO.Al₂O₃.SiO₂, and the fuel activation catalyzer commonly. preferably has the shape of honeycomb.

The nanometer negative ions and far infrared materials can include the following components: combined water-H2O⁺, AL₂O₃, K₂O, SiO₂ and Fe₂O₃.

The nanometer negative ions and far infrared materials also can include the following components: MgO, Na₂O, CaO, absorbed water-H₂O⁻, TiO₂, FeO, P₂O₅ and/or Mn.

The weight percentage of each component of the nanometer negative ions and far infrared materials in the materials is as the following: 1-3 wt % of combined water-H₂O⁺, 5-15 wt° /0 of AL₂O₃, 0.5-2 wt % of K₂O, 0-10 wt % of P₂O₅, 0-10 wt % of Mn, 50-80 wt % of SiO₂, 0.5-5 wt % of Fe₂O₃, 0-2 wt % of MgO, 0-2 wt % of Na₂O, 3-15 wt % of CaO, 0-6 wt % of absorbed water -H₂O″, 0-10 wt % of TiO₂ and 0-5 wt % of FeO.

The exterior appearance of the nanometer negative ions and far infrared materials presents grey or white; average grain diameter is 10-60 nm; the pH value of water suspension is 7; specific surface area is 15-25 m²./g; stacking density is 0.4-0.8 g/ml; loss on drying is 2-5 wt %; negative ions generating contrast concentration is about 4-6.5 times; and heat resisting property is larger than 500 DEG C.

The manufacture method of the fuel activation catalyzer for the energy saver of the internal combustion engine comprising the steps of mixing the nanometer negative ions and far infrared materials which are taken as a base with the cordierite ceramic raw material, and performing extrusion forming by using a honeycomb ceramics extrusion forming technology, wherein working detailed procedures may include the following steps of: material preparing, powder mixing, mud preparing, sieving, vacuum mud preparing, high pressure forming, shaping drying, manual refining, high pressure sintering and cooling.

In the method, the weight of the nanometer negative ions and far infrared materials to the total weight of the nanometer negative ions and far infrared materials and the carrier is 5 wt %-30 wt %.

The energy saver of the internal combustion engine includes an air cleaner and the catalyzer arranged therein.

In the energy saver of the internal combustion engine, the catalyzer preferably has the shape of honeycomb.

By including the nanometer composite material, the fuel activation catalyzer for the energy saver of the internal combustion engine can simultaneously improve oil circuit and gas circuit, promotes combustion, increases the combustion heat value of the fuel, enhances the power of the internal combustion engine under equal fuel, and can avoid blocking an oil delivery pipe, having a significant effect for cleaning and improving the pollution of the oil circuit.

### DETAILED DESCRIPTION

The energy saver of the internal combustion engine consists of the fuel activation catalyzer and the air cleaner. The working principle of the fuel activation catalyzer and the air cleaner is characterized in that: I. The fuel activation catalyzer takes nanometer rare earth composite material as core material; the chemical composition of the nanometer negative ions and far infrared materials may include the following eleven components: 1-3% of combined water —H₂O⁺, 5-15% of AL₂O₃, 0.5-2% of K₂O, 0-10% of P₂O₅, 0-10% of Mn, 50-80% of SiO₂, 0.5-5% of Fe₂O₃, 0-2% of MgO, 0-2% of Na₂O, 3-15% of CaO, 0-6% of absorbed water -H2O⁻, 0-10% of TiO₂ and 0-5% of FeO; and when taking the cordierite ceramic material as the carrier, the fuel activation catalyzer for the energy saver of the internal combustion engine can be made by means of extrusion forming. By being irradiated by light with the wave length less than 400 nm, valence band electrons are activated to react with O₂ and H₂O which are attached on the surface thereof, so as to generate oxide hydroxide radical free radical-OH. The hydroxide radical free radical has strong oxygenolysis being able to break C—C chain, C—C bond, C—O bond and O—H bond, effectively absorb heat energy, and release far infrared ray which is characterized by the wave length of 8-20 um and the vibration frequency of 280,000-320,000 Hz. Carbon hydrogen atom in the fuel oil is exactly locked and molecular group of the fuel oil is instantaneously changed into micromolecules by means of molecular resonance to evenly arrange the molecular group positive electric ions and the molecular group negative electric ions, increase the activeness and the preheat effect of the fuel, instantaneously catalyze oil molecules with high fire point in the fuel oil, completely atomize the fuel oil from liquid state to semi-gas state before the fuel oil enters into a jetting device or a carburetor, generate negative oxygen ions with high seepage force, and improve the oxygen dissolubility of the oil molecules. 2. The air cleaner is made from the ring structural silicate composite nanometer material of aluminum, sodium, iron lithium, which is characterized. by including boron, thereby having pyroelectricity and piezoelectricity. Change of the temperature and the pressure (even if subtle change) can generate electric potential difference between crystalloids, wherein the static electricity may be up to 1 million electron volt, so that the air can be ionized and the electrically shocked electrons attach to adjacent water and oxygen molecules to converted the same into air negative ions, namely, negative oxygen ions which have a contrast concentration of 10000-50000 numbers/cu.cm. The negative oxygen ions move in the air in a Z-shaped orbit, transport negative charges to dusty, smoke, particulate, water drop and the like, so as to clean the air, effectively change the quality of the oxygen molecules in the air, and further to evenly mix the oil molecules with the oxygen to achieve the best air-fuel ratio. Because the quality of the fuel molecules and the oxygen molecules is improved and the combustion heat value is increased, the fuel oil can combust fast after being fired to enhance generated power and improve the power performance of the internal combustion engine. Therefore, not only the fuel oil can be completely combusted, but also the power of the internal combustion engine can be improved, harmful gas in exhaust gas is oxidized and decomposed, catalyst of tail gas in a muffler is activated, and the harmful gas in pollutants of the tail gas is reduced, specifically, CO is reduced by 50% at least, CH is reduced by 30% at least and NₓO is reduced by 10% at least to prolong the service life of three-way catalyst. Oil-saving efficiency can approximately attain 8-15%.

The fuel activation catalyzer for the energy saver of the internal combustion engine can be made into the shape of honeycomb by means of extrusion forming, preferably by hydraulic forming. For example, when the cordierite ceramic material is taken as the carrier, the machining process of the catalyzer is specifically as the following:

Step one, material preparing: preparing the nanometer negative ions and far infrared materials, the weight of which is 5 wt %-30 wt % of the total weight of the fuel activation catalyzer for the energy saver of the internal combustion engine, and the cordierite ceramic material, the weight of which is 70 wt %-95 wt % of the total weight.

Step two, mixing: 1. mixing device. Performance requirements on the device includes that: the mixture uniformity is high; residual quantity of the material in a container is less; grain of homogeneous material is small and texture thereof is delicate; the device is simple in structure, is stable and durable, and is convenient to operate, visually inspect, sample, clean and maintain; the mechanical device has the performances of rust prevention and corrosion prevention, the surface of the container is smooth, and work parts can be disassembled and cleaned; and an electric motor and electric control equipment can prevent explosion, wetness and dust. Thus a V-shaped mixing device is most applicable. 2. Mixing speed and mixing time. The mixing speed is a disappear speed of difference between a material actual state in the process of mixing and a material final state that the components are randomly completely mixed. 3. Before mixing, adding bond, the weight of which is 5 wt % of the total weight of the mixture, wherein the bond is preferably selected from dextrine and cellulose, and is especially preferably selected from carboxymethylcellulose and carboxymethyl hydroxypropyl cellulose.

Step three, mud mixing and mud preparing: adding water, the weight of which is 15 wt % of the total weight of the mixture, evenly stirring the mixture to prepare powder body into mud; and carrying out vacuum mud preparing (vacuum densification)with a required pressure of 6-12 Pa.

Step four, forming: adopting a hydraulic forming method, according to a designed mould, to extrude the mud into a certain geometric shape.

Step five, drying: adopting a microwave oven drying method for drying and shaping, in which the shaped material is shaped in the microwave oven for 3 minutes under the temperature from 80 DEG C to 120 DEG C and is dried in a bellows for 4 hours under the temperature from 200 DEG C to 300 DEG C.

Step six, refining: making the material into a required scale, such as 25 cm*51 cm*11 cm (W*L*H).

Step seven, sintering: sintering at a temperature from 500 DEG C to 1000 DEG C for more than 3 hours.

Step eight, finish machining: carrying out further finish machining to the material according to the exact exterior appearance data of the products.

Step nine, testing: testing the products according to product requirement.

The present patent application is specifically illustrated by the following embodiments, wherein the embodiments are only taken as a further illustration for the present patent application but can not be illustrated as limitation to the protection range of the present patent application.

### EMBODIMENT 1

The invention includes the steps of following: weighing 10 kg of the nanometer negative ions and far infrared materials and 190kg of the cordierite ceramic material; adding 10 kg of carboxymethylcellulose; evenly string and mixing; adding 30 kg of water and stirring into mud; carrying out vacuum mud preparing under the pressure of 8 Pa; obtaining the required honeycomb shape by means of hydraulic forming; shaping for 3 minutes under the temperature of 100 DEG C; drying for 4 hours under the temperature of 200 DEG C; refining to obtainthe required scale; sintering for 10 hours under the temperature of 500 DEG C; and carrying out finally finish machining to obtain the honeycomb-shaped catalyzer for the energy saver of the internal combustion engine.

The nanometer negative ions and far infrared materials specifically comprises the following components: 1-3% of combined water —H₂O+, 5-15% of AL₂O₃, 0.5-2% of K₂O, 0-10% of P₂O₅, 0-10% of Mn, 50-80% of SiO₂, 0.5-5% of Fe₂O₃, 0-2% of MgO, 0-2% of Na2O, 3-15% of CaO, 0-6% of absorbed water-H₂O—, 0-10% of TiO₂ and 0-5% of FeO.

### EMBODIMENT 2

Weighing 20 kg of the nanometer negative ions and far infrared materials and 180 kg of the cordierite ceramic material; adding with 10 kg of carboxymethylcellulose; evenly string and mixing; adding with 30 kg of water and stirring into mud; vacuum mud preparing under the pressure of 10 Pa; obtaining the required honeycomb shape by means of hydraulic forming; shaping for 3 minutes under the temperature of 120 DEG C; drying for 4 hours under the temperature of 250 DEG C; refining to obtain the required scale; sintering for 8 hours under the temperature of 700 DEG C; and finally finish machining to obtain the honeycomb-shaped catalyzer for the energy saver of the internal combustion engine.

The nanometer negative ions and far infrared materials specifically comprises the following components: 1-3% of combined water —H₂O+, 5-15% of AL₂O₃, 0.5-2% of K₂O, 0-10% of P₂O₅, 0-10% of Mn, 50-80% of SiO₂, 0.5-5% of Fe₂O₃, 0-2% of MgO, 0-2% of Na₂O, 3-15% of CaO, 0-6% of absorbed water-H20-, 0-10% of TiO2 and 0-5% of FeO.

### EMBODIMENT 3

Weighing 40kg of the nanometer negative ions and far infrared materials and 160kg of the cordierite ceramic material; adding 10kg of carboxymethylcellulose; evenly string and mixing; adding 30kg of water and stirring into mud; carrying out vacuum mud preparing under the pressure of 12Pa; obtaining the required honeycomb shape by means of hydraulic forming; shaping for 3 minutes under the temperature of 100 DEG C; drying for 8 hours under the temperature of 300 DEG C; refining to obtain the required scale; sintering for 4 hours under the temperature of 1000 DEG C; and carrying out finally finish machining to obtain the honeycomb-shaped catalyier for the energy saver of the internal combustion engine.

The nanometer negative ions and far infrared materials specifically comprises the following components: 1-3% of combined water —H₂O+, 5-15% of AL₂O₃, 0.5-2% of K₂O, 0-10% of P₂O₅, 0-10% of Mn; 50-80% of SiO2, 0.5-5% of Fe₂O₃, 0-2% of MgO, 0-2% of Na₂O, 3-15% of CaO, 0-6% of absorbed water-H₂O—, 0-10% of TiO₂ and 0-5% of FeO.

### EMBODIMENT 4

Weighing 60 kg of the nanometer negative ions and far infrared materials and 140 kg of the cordierite ceramic material; adding 10 kg of carboxymethylcellulose; evenly string and mixing; adding 30 kg of water and stirring into mud; carrying out vacuum mud preparing under the pressure of 10 Pa; obtaining the required honeycomb shape by means of hydraulic forming; shaping for 3 minutes under the temperature of 120 DEG C; drying for 8 hours under the temperature of 300 DEG C; refining to obtain the required scale; sintering for 4 hours under the temperature of 1000 DEG C; and carrying out finally finish machining to obtain the honeycomb-shaped catalyzer for the energy saver of the internal combustion engine.

The nanometer negative ions and far infrared materials specifically comprises the following components: 1-3% of combined water —H₂O+, 5-15% of AL₂O₃, 0.5-2% of K₂O, 0-10% of P₂O₅, 0-10% of Mn, 50-80% of SiO₂, 0.5-5% of Fe₂O₃, 0-2% of MgO, 0-2% of Na₂O, 3-15% of CaO, 0-6% of absorbed water-H₂O—, 0-10% of TiO' and 0-5% of FeO.

### EMBODIMENTS 5-8

Replacing the cordierite ceramic material with the limestone and repeating the steps of the embodiments 1-4 to form the new embodiments.

Then, respectively testing technical targets of the fuel activation catalyzers for the energy saver of the internal combustion engine with normal test method, wherein the activation catalyzers are prepared by the embodiments 1-8, and specifically taking the embodiment 2 as an example:

Thermal shock resistance:

Compression strength before thermal shock: A axle is 18 MPa and B axle is 2.5 MPa

Compression strength after thermal shock: A axle is 27 MPa and B axle is 2.3 MPa

RT-500 DEG C the strength lose after three cycles is less than 10%

Water absorbing capacity: 10%

Vibration resistance:

Stated vibration experiment condition:

| Vibration | Vibration | | | |
|---|---|---|---|---|
| frequency | acceleration | Experiment Time | | |
| (Hz) | (m/s2) | (H) | | |
| 67 | 110 | Up and down | Left and right | Front and back |
| | | 2 | 2 | 2 |

Sweep frequency vibration experiment condition:

| Sweep | | | Sweep |
|---|---|---|---|
| frequency | Displacement amplitude | Period | frequency |
| range | or Acceleration | (min) | times |
| 25-200 | 25-60 Hz: 0.78 mm | 15 | 10 |
| | 60-200 Hz: 11 m/s2 | | |

It is noteworthy that the detailed description specifically illustrates the technical proposals of the present patent application with the embodiments, however, the skilled in the art easily thinks of the detailed description, and changes and modifies the technical proposals of the present patent application based thereon, but not breaking away from a range summarized by the claims which are requested for protection by the present invention.

What is claimed is:

1. A fuel activation catalyzer for an energy saver of an internal combustion engine including nanometer negative ions and far infrared materials, and carrier of the nanometer negative ions material selected from the following material(s): cordierite ceramic material and/or limestone, wherein the weight of the nanometer negative ions and far infrared materials to the total weight of the nanometer negative ions and far infrared materials and the carrier is 5 wt %-30 wt %.

2. The fuel activation catalyzer of claim I, wherein the nanometer negative ions and far infrared materials include the following components: combined water-H₂O⁺, AL₂O₃, K₂O, SiO₂ and Fe₂O₃.

3. The fuel activation catalyzer of claim 2, wherein the nanometer negative ions and far infrared materials also can include the following components: MgO, Na₂O, CaO, absorbed water-H₂O⁻, TiO₂, FeO, P₂O₅ and/or Mn.

4. The fuel activation catalyzer of claim 3, wherein the nanometer negative ions and far infrared materials comprising the following components, by weight percentage: 1-3 wt % of combined water-H₂O⁺, 5-1 5 wt % of A L₂O₃, 0.5-2 wt % of K₂O, 0-10 wt % of P₂O₅, 0-10 wt % of Mn, 50-80 wt % of SiO₂, 0.5-5 wt % of Fe₂O₃, 0-2 wt % of MgO, 0-2 wt % of Na₂O, 3-15 wt % of CaO, 0-6 wt % of absorbed water-H₂O⁻, 0-10 wt % of TiO₂ and 0-5 wt % of FeO.

5. The fuel activation catalyzer of any one of claims 1-4, wherein the carrier(s) are/is cordierite ceramic material and/or limestone.

6. The energy saver of the internal combustion engine of claim 5, wherein the carrier is the cordierite ceramic material with chemical composition being MgO.Al₂O₃.SiO₂.

7. The fuel activation catalyzer of any one of claims 1-4, wherein the fuel activation catalyzer has the shape of honeycomb.

8. The fuel activation catalyzer of any one of claims 1-4, wherein the exterior appearance of the nanometer negative ions and far infrared materials is grey or white; average grain diameter is 10-60 nm; the pH value of water suspension thereof is 7; specific surface is 15-25 m²./g; stacking density is 0.4-0.8 g/ml; loss on drying is 2-5 wt %; negative ions generating contrast concentration is 4-6.5 times; and heat resisting property is larger than 500 DEG C.

9. A manufacture method of the fuel activation catalyzer of any one of claims 1-7 comprising the steps of mixing the nanometer negative ions and far infrared materials with the ceramic raw material such as the cordierite and the like, and using a honeycomb ceramics extrusion forming technology to prepare, wherein working procedures may include the following steps of material preparing, powder mixing, mud preparing, sieving, vacuum mud preparing, high pressure forming, drying shaping, manual refining, high pressure sintering, cooling, testing and packaging.

10. The method of claim 9, wherein the weight of the nanometer negative ions and far infrared materials to the total weight of the nanometer negative ions and far infrared materials and the carrier is 5 wt %-30 wt %.

11. An energy saver of an internal combustion engine comprising an air cleaner and the catalyzer arranged therein of any one of claims 1-8.

12. The energy saver of the internal combustion engine of claim 11, wherein the catalyzer has the shape of honeycomb.
